(19) United States
(12) Patent Application Publication
(10) Pub. No.: US 2009/0003222 A1
(43) Pub. Date: Jan. 1, 2009

(54) PACKET COMMUNICATION QUALITY MEASURING APPARATUS, PROGRAM, AND METHOD

(75) Inventors: Noriyuki FUKUYAMA, Kawasaki (JP); Masanobu Morinaga, Kawasaki (JP); Hideaki Miyazaki, Kawasaki (JP); Sumiyo Okada, Kawasaki (JP)

Correspondence Address: STAAS & HALSEY LLP, SUITE 700, 1201 NEW YORK AVENUE, N.W., WASHINGTON, DC, 20005, US

(73) Assignee: FUJITSU LIMITED, Kawasaki (JP)

(21) Appl. No.: 12/140,027

(22) Filed: Jun. 16, 2008

(30) Foreign Application Priority Data
Jun. 27, 2007 (JP) 2007-168835

(51) Int. Cl. H04L 12/26; G08C 15/00

(52) U.S. Cl. 370/242; 370/252

(57) ABSTRACT

A packet communication quality measuring apparatus for capturing packets flowing in a packet communication network while recording capture times to measure communication quality based on the captured packets includes a detection part for detecting that a buffer in which the captured packets are stored is full and a determination part for determining a possibility of a capture failure occurring when fullness of the buffer is detected.

### CROSS-REFERENCE TO RELATED APPLICATIONS

This application is based upon and claims the benefit of priority from the prior Japanese Patent Application No. 2007-168835 filed on Jun. 27, 2007, the entire contents of which are incorporated herein by reference.

### TECHNICAL FIELD

The present invention relates to an apparatus and method for capturing packets flowing in a packet communication network and measuring communication quality based on the captured packets, and in particular, relates to a packet communication quality measuring apparatus and method for preventing measurements in which a capture failure is incorrectly measured as a packet loss in a packet communication network by detecting the capture failure with high accuracy.

### BACKGROUND OF THE INVENTION

Communication systems such as IP telephony via a packet communication network are coming into widespread use with technologies such as VoIP (Voiceover Internet Protocol).

Japanese Patent Application Laid-Open (JP-A) No. 2005-159807 discloses a conventional technology to control communication quality in a packet communication network using VoIP and the like.

The document describes a technology in which a communication quality value such as a loss rate of packets flowing in a packet communication network is measured and the packet communication network is monitored by comparing the measured communication quality value with a control reference value preset by a network administrator to detect a communication state.

JP-A-2003-204358 discloses a conventional technology to detect that an intrusion of an unauthorized access packet occurred by monitoring network traffic to analyze packets flowing in the network.

However, according to the method disclosed by JP-A-2005-159807, all packets are captured and communication quality is measured based on all the captured packets and thus, the load needed for measurement of communication quality increases with an increasing quantity of packets. As a result, packet processing cannot keep up with capturing of packets and an overflow of a set of buffers in which packets after being captured are temporarily stored occurs. Thus, a problem of measuring precision arises because an occurrence of capture failure of packets is mistaken for a loss in a network, which is then issued as a measurement result.

According to the method disclosed by JP-A-2003-204358, when packets are captured beyond the number of packets that can be processed per unit time, the number of packets that can be processed is increased by decreasing the amount of processing, but minimum processing is necessary. In any case, there arises a limit with increasing traffic.

Generally when there is such a limit of processing, measures such as (1) Use an apparatus capable of faster processing, (2) Reduce the load by distributing processing, and (3) Do not guarantee operations in a state beyond a limit are taken.

However, when measures of (1) or (2) are taken, there is a problem of more expensive apparatuses and higher costs when apparatuses are widely distributed for monitoring. When measures of (3) are taken, it becomes impossible for, e.g., communication operators or large-scale users to monitor a network.

As an approach like a symptomatic treatment, (4) Make a capture failure in an apparatus detectable by using specific hardware (NIC: Network Interface Card) or a driver thereof can also be considered.

Further, (5) Information provided by an NIC or NIC driver may also be acquired from the OS (Operating System) to make a determination.

However, the approach in (4) makes operation verification necessary whenever a hardware or a driver is changed, and there is inconvenience that no measuring apparatus can be supplied when the hardware is not provided.

The number of packets having a CRC error or the like must be excluded when the approach in (5) is taken, and there are problems in that different items are allocated depending on a driver and there is a time lag between update timing of NIC driver information and function call timing.

### SUMMARY

According to an aspect of an embodiment, a packet communication quality measuring apparatus and method capable of preventing communication quality measurement such as a determination whether there was a loss in a network based on packets captured in a period in which a capture failure may have occurred by detecting a possibility of a capture failure of packets based on a state of a set of buffers in which captured packets are stored.

According to an aspect of an embodiment, there is provided a packet communication quality measuring apparatus that captures packets flowing in a packet communication network while recording capture times to measure communication quality based on the captured packets, the packet communication quality measuring apparatus including: detection unit which detects that a buffer in which the captured packets are stored is full; and determining unit which determining a possibility of a capture failure temporarily occurred when fullness of the buffer is detected.

In a preferred embodiment, the detection unit includes a recording unit which records a time PTm at which a packet Pm is extracted from the buffer and processed, a stored packet number acquiring unit which acquires the number N of stored packets at PTm, by counting the number of processed packets from Pm to Pn, when a packet having a capture time CTn earlier than PTm and closest to PTm is Pn, and a determining unit which determines whether N has reached a maximum number Nmax of packets that can be stored in the buffer.

In another preferred embodiment, the detection unit includes a unit which determines the number N of stored packets by extracting all packets stored in the buffer at a time and a unit which determines whether N has reached a maximum number Nmax of packets that can be stored in the buffer.

Moreover, it is preferable that the packet communication quality measuring apparatus further includes a unit for prevents packets captured in a period in which a capture failure may have occurred from being subjected to packet(s) loss determination based on sequence numbers.

Further, according to the present invention, there are provided a packet communication quality measuring method having the same technical features as those of the above packet communication quality measuring apparatus and a program causing a computer to function as a packet communication quality measuring apparatus.

In a packet communication quality measuring apparatus and method according to the present invention, in a packets capturing period fullness of a buffer is detected, so that a possibility of a capture failure of packets is pointed out, and therefore the judgment such as whether there was a packet loss that capture was done at the period with the possibility of a capture failure occurs on the network is prevented from doing.

Therefore, a capture failure is prevented from being incorrectly measured as a packet loss in a packet communication network without relying on a specific hardware.

### BRIEF DESCRIPTION OF THE DRAWINGS

FIG. 1 is a block diagram showing an embodiment of a packet communication quality measuring apparatus according to the present invention;

FIG. 2 is a diagram for theoretically illustrating packet capturing, buffer content, packet processing, a buffer content determination, and a determination of the number of stored packets in sequential processing;

FIG. 3 is like FIG. 2 and is a diagram for illustrating a capture failure;

FIG. 4 is a flow chart showing an algorithm of a routine for detecting a capture failure in sequential processing;

FIG. 5 is a diagram for theoretically illustrating packet capturing, buffer content, packet processing, a buffer content determination, and a determination of the number of stored packets in batch processing; and

FIG. 6 is a flow chart showing an algorithm of a routine for detecting a capture failure in batch processing.

### DETAILED DESCRIPTION OF THE EMBODIMENT

An embodiment of the present invention will be described with reference to the attached drawings.

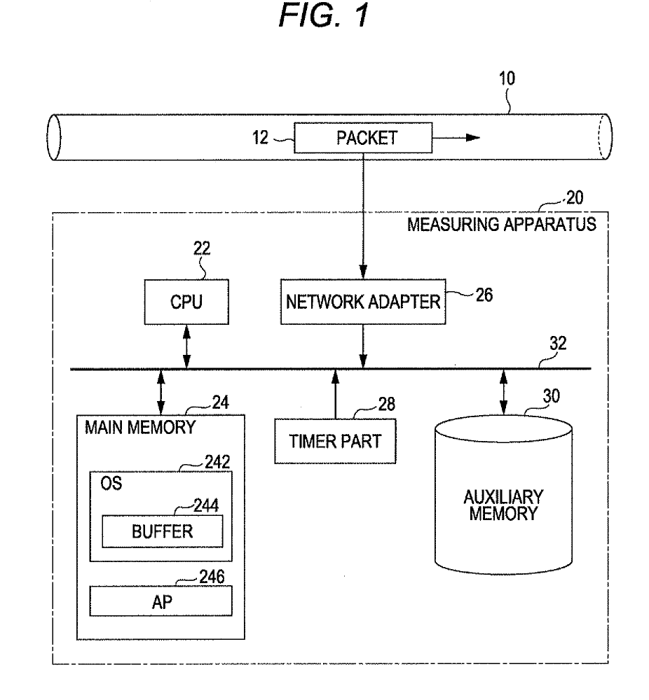

FIG. 1 is a block diagram showing an embodiment of a packet communication quality measuring apparatus 20 according to the present invention.

As shown in FIG. 1, the packet communication quality measuring apparatus 20 includes a central processing unit (CPU) 22, a main memory 24, a network adapter 26, a timer part 28, an auxiliary memory 30, and a bus 32 connecting these components.

The network adapter 26 is connected to the network 10 thereby to receive Internet protocol (IP) packets 12 transmitted over a packet communication network 10 or transmit the IP packets 12 to the network 10.

The network adapter 26 includes, for example, a network interface card (NIC).

The measuring apparatus 20 measures communication quality by capturing the packets 12 using the network adapter 26.

The timer part 28 is used to record capturing times and the like as a clock inside the measuring apparatus 20.

The CPU 22 realizes packet communication quality measuring processing by operating according to a program loaded from the auxiliary memory 30 to the main memory 24.

An operating system (OS) 242 loaded into the main memory 24 receives particularly together with driver software thereunder the packets 12 from the network 10 to realize functions stored in a buffer 244 reserved in a kernel area or the like of the OS.

An application program (AP) 246 loaded into the main memory 24 measures a communication quality value such as a loss rate of packets by extracting and processing packets stored in the buffer 244 and realizes a function to detect the communication quality level by comparing the measured communication quality value with a threshold value preset by a network administrator.

Even if processing performance of a measuring apparatus is low, the apparatus with a network interface of 100 Mbps (Mega bit per second) or 1 Gpbs (Giga bit per second) can receive IP packets at a wire speed in terms of hardware.

However, on a measuring apparatus with low processing performance, the number of processed packets in a unit time may be smaller than that of received packets per unit time when the apparatus extracts specific packets (for example, voice packets) or measures/analyzes (for example, analyzing missed sequence numbers of voice packets) simultaneously. Thus, processing delay of received packets waiting to be processed causes a capture failure.

That is, received packets waiting to be processed are stored in the buffer 244. When the buffer 244 becomes full, the buffer 244 can no longer store packets, leading to a capture failure.

The present invention provides an algorithm for determining the rate of utilization of the buffer 244 and the determination thereof points out a possibility of a capture failure occurring if the buffer 244 is full.

Depending on the functions of the OS 242, only one packet may be extractable at a time from the buffer 244 in a kernel area or the like of the OS (that is, sequential processing), or all packets received from the buffer 244 may be extractable at a time (that is, batch processing).

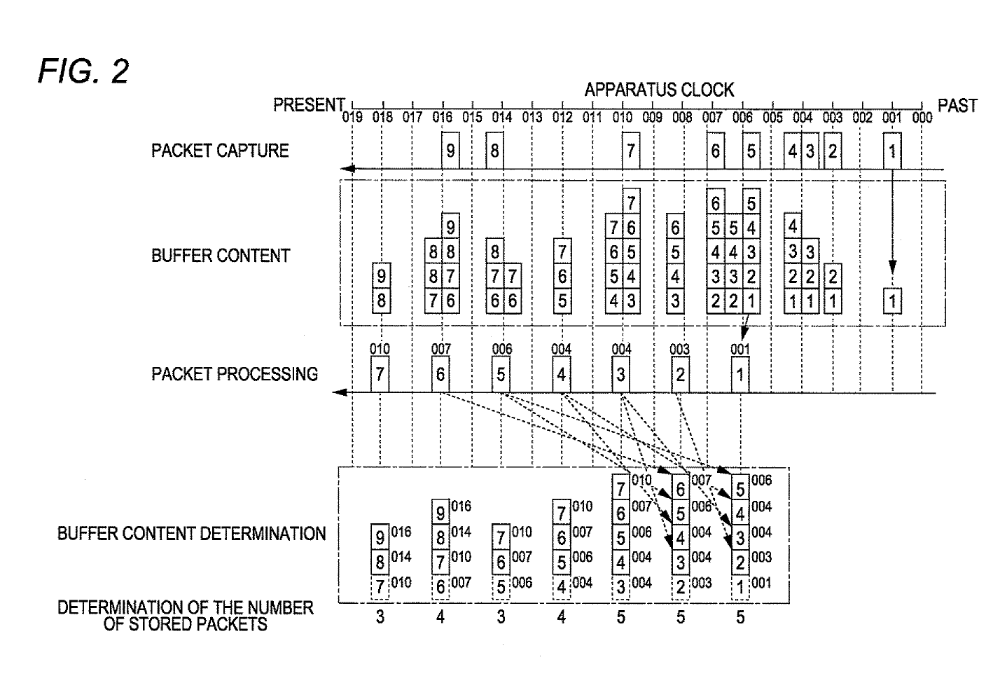

FIG. 2 is a diagram for theoretically illustrating packet capturing, buffer content, packet processing, a buffer content determination, and a determination of the number of stored packets in sequential processing.

As shown in FIG. 2, a packet 1 is captured at time 001 and stored in the buffer 244 with the capture time 001.

Next, a packet 2 is captured at time 003 and stored in the buffer 244 with the capture time 003.

Likewise, packets 3 to 9 are captured and stored in the buffer 244 with each capture time.

Since such capturing and storing of packets is performed under control of the OS 242, the application program 246 cannot see content of the buffer 244.

On the other hand, the application program 246 performing sequential processing, as shown in FIG. 2, extracts the packet 1, which is the first packet, from the buffer for processing at time 006 and records, at this point, the processing time 006 for the packet 1.

Thus, the application program 246 recognizes that the packet 1 is already stored in the buffer at time 006.

Next, the application program extracts the packet 2 from the buffer for processing at time 008 and records the processing time 008 for the packet 2.

Thus, the application program 246 recognizes that the packet 2 is already stored in the buffer at time 008.

At the same time, the application program recognizes that the packet 2 is already stored in the buffer at the processing time 006 of the packet 1 to detect that the capture time of the packet 2 is 003.

Next, the application program extracts the packet 3 from the buffer for processing at time 010 and records the processing time 010 for the packet 3.

Thus, the application program recognizes that the packet 3 is already stored in the buffer at time 010.

At the same time, the application program recognizes that the packet 3 is already stored in the buffer at the processing time 006 of the packet 1 and at the processing time 008 of the packet 2 to detect that the capture time of the packet 3 is 004.

Likewise, the packets 4 to 7 are processed.

When processing of the packet 6 is completed, the application program recognizes that the capture time of the packet 6 is 007 and also recognizes that while the packet 6 was not present in the buffer at the processing time 006 of the packet 1, the packet 6 was stored in the buffer at the processing time 008 of the packet 2.

It is revealed in this way that at the processing time 006 of the packet 1, the number of stored packets is 5 with the packet 1, packet 2, packet 3, packet 4 and packet 5.

In the same manner, the number of stored packets at the processing time of each packet will sequentially be determined.

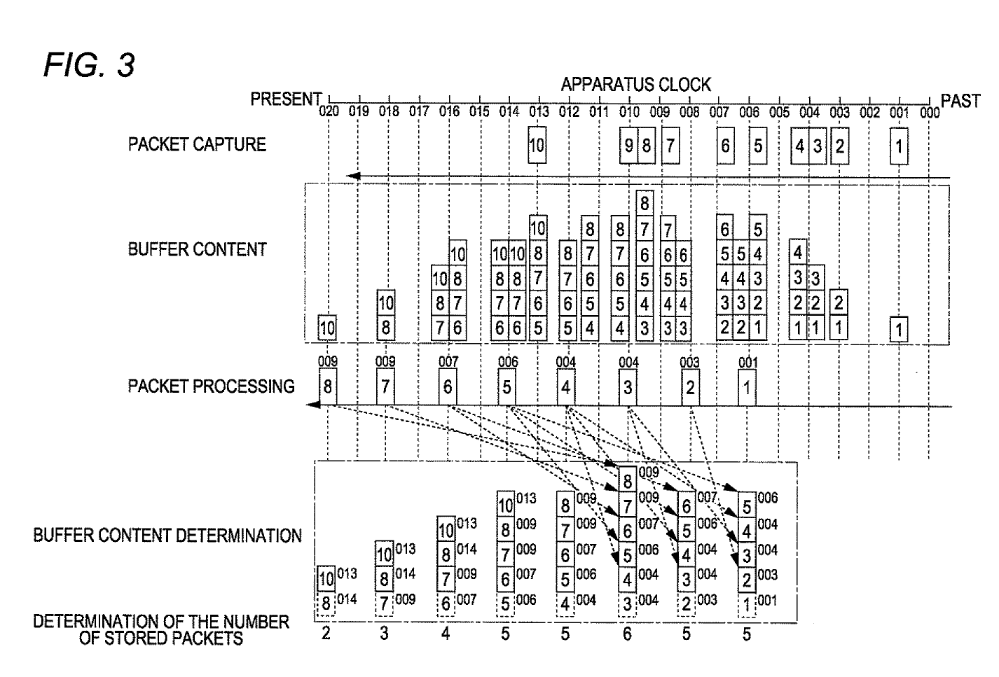

FIG. 3 is like FIG. 2 and is a diagram for illustrating a capture failure.

It is assumed, for example, that the number of packets that can be stored in the buffer is 6.

In that case, as shown in FIG. 3, the buffer becomes full when the packet 8 is captured.

If, in that state, the packet 9 flows in a network, the measuring apparatus 20 cannot capture the packet 9, that is, a capture failure occurs.

Subsequently, when the application program extracts a packet from the buffer to end fullness of the buffer, a new packet 10 can be captured.

Thus, when the buffer is full, the application program can determine that a capture failure may temporarily occur.

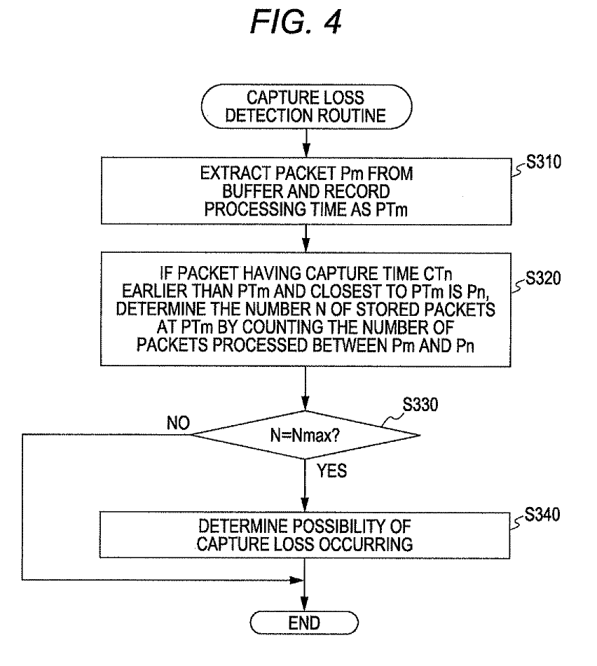

An algorithm of a routine for detecting a capture failure in sequential processing based on the above principle is shown in a flow chart in FIG. 4.

As described above, each packet in the buffer 244 is stored in the buffer 244 with the capture time when captured.

First, the application program 246 extracts one packet Pm from the buffer 244 for processing and also records the processing time therefor as PTm (step 310).

Next, if a packet having the capture time CTn earlier than the time PTm and closest to the time PTm is Pn, the number N of stored packets in the buffer 244 at the time PTm is determined by counting the number of packets processed between packet Pm processing and packet Pn processing (including Pm and Pn) (step 320).

Next, the application program 246 determines whether the number N of stored packets has reached a maximum number Nmax of packets that can be stored in the buffer 244 (step 330).

Then, if N=Nmax, the application program 246 determines that a capture failure may occur (step 340).

Thus, the application program 246 can prevent packets captured in a period in which a capture failure could have occurred from being subjected to packet(s) loss determination based on sequence numbers contained in packets such as voice packets (RTP (Real-time Transport Protocol) packets) in VoIP.

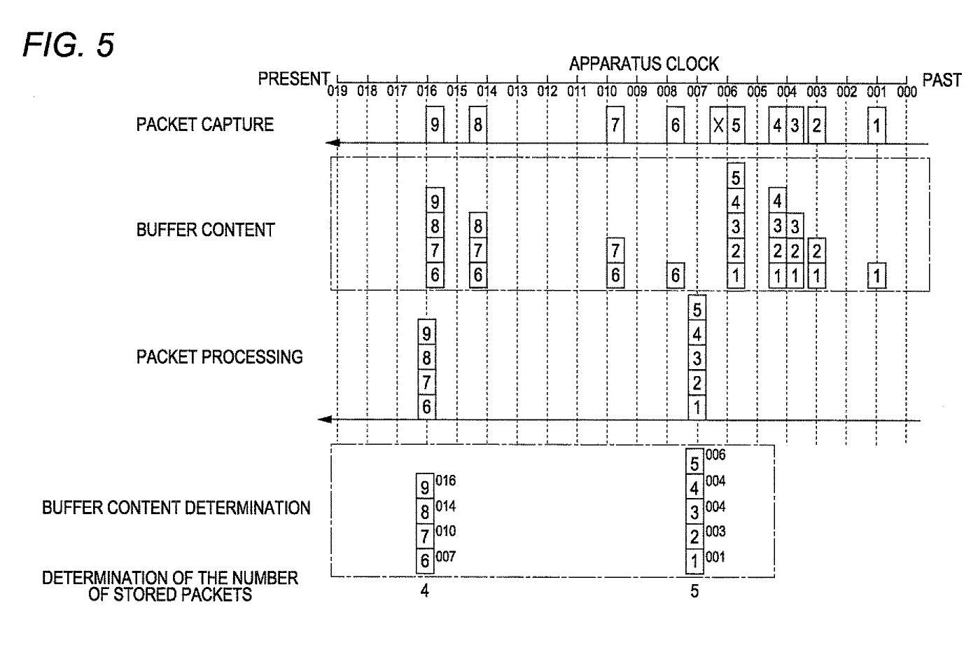

FIG. 5 is a diagram for theoretically illustrating packet capturing, buffer content, packet processing, a buffer content determination, and a determination of the number of stored packets in batch processing.

It is assumed, for example, that the number of packets that can be stored in the buffer is 5.

In that case, as shown in FIG. 5, the buffer becomes full when the packet 5 is captured.

If, in that state, a packet X arrives, the measuring apparatus 20 cannot capture the packet X.

That is, a capture failure occurs.

On the other hand, all packets stored in the buffer can be extracted at a time in batch processing and therefore, the number of stored packets at the time of batch processing can directly be detected.

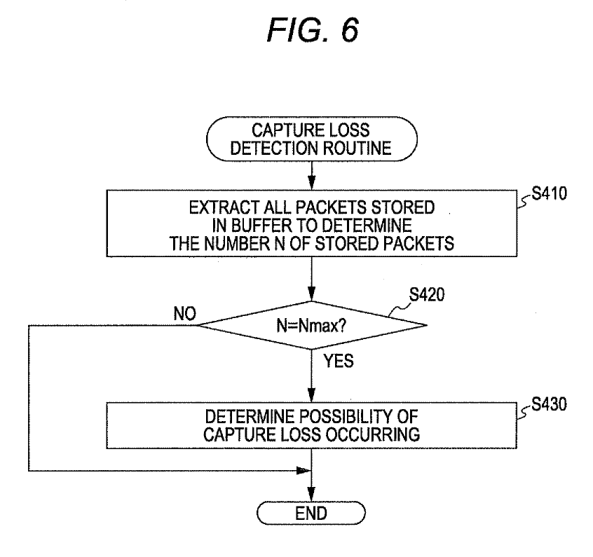

An algorithm of a routine for detecting a capture failure in such batch processing is shown in a flow chart in FIG. 6.

First, the application program 246 determines the number N of stored packets in the buffer 244 by extracting all packets stored in the buffer 244 (step 410).

Next, the application program 246 determines whether the number N of stored packets has reached the maximum number Nmax of packets that can be stored in the buffer 244 (step 420).

Then, if N=Nmax, the application program 246 determines that a capture failure may occur (step 430).

Then, like in sequential processing, the application program 246 can prohibit packets captured in a period in which a capture failure could have occurred from being subjected to packet(s) loss determination based on sequence numbers.

In sequential processing, the correct number of stored packets may not be measurable when, for example, the capture time is not correctly recorded.

In such a case, a capture failure can approximately be detected according to a method described below.

A limit value of a packet size in which a capture failure occurs in a measuring apparatus is determined in advance and the packet size is defined as minS (byte).

How to determine minS will be exemplified below.

(1) Connect a measuring apparatus and a packet transmitter for transmitting packets to the measuring apparatus to the same network.

(2) Operate a process to impose a load on the CPU of the measuring apparatus.

(3) Transmit packets of a packet size S from the packet transmitter for about a minute at a wire speed to be captured by the measuring apparatus.

(4) Start the packet size S from the maximum size (1500 bytes for the Ethernet (registered trademark)) and repeat the above measurement by sequentially decrementing the packet size for each measurement.

(5) Define the size that causes a capture failure first in the above measurement results as minS.

If, in this case, all obtained packets have packet sizes exceeding minS, it is determined that no capture failure has occurred.

If any packet size equal to or less than minS is contained in the packets, it is determined that a capture failure may have occurred.

When determining minS, a lower limit minS_ave of the average packet size that can be obtained without causing a capture failure may be determined by generating the packet size using a random number with an average packet size S. Then, if the average size of obtained packets is equal to or more than minS_ave, it is determined that no capture failure has occurred and, if the average size of obtained packets is less than minS_ave, it is determined that a capture failure may have occurred.

To prevent an incorrect determination that no capture failure has occurred even if a capture failure has actually occurred, the packet size of minS_ave+α may be used as the reference.

In this case, α can be determined by an experiment in which measurement of minS_ave is repeated a plurality of times to determine the standard deviation σ thereof and then setting α=3σ, which almost guarantees 100% freedom from false determination.

As another approximate capture failure detection technique, possibilities of a capture failure can be determined by examining how many minimum packet size (which is a size excluding the header of an IP packet and at least 64 bytes in the whole size) packets coming in succession cause a capture failure.

An upper limit maxN of the number of packets that does not cause a capture failure is determined by increasing the number of packets having the minimum packet size and continuously flown into a network at a wire speed from 1.

At this point, the processing time of maxN packets is defined as maxT.

In this case, as long as maxN packets or less are obtained in the maxT time, it is determined that no capture failure has occurred and, if more than maxN packets are obtained in the maxT time, it is determined that a capture failure may have occurred.

Since there is a possibility of false detection caused by different loads on the measuring apparatus during measurement of maxT and maxN and during actual operation, a margin such as maxN−α and maxT+β may be inserted for actual operation.

At this point, α can be determined by repeating a plurality of experiments to measure maxN to determine the standard deviation σN of maxN and setting α=3σN, which almost guarantees 100% freedom from false determination.

Similarly, β can be determined by repeating a plurality of experiments to measure maxT to determine the standard deviation σT of maxT and setting α=3σT, which almost guarantees 100% freedom from false determination.

What is claimed is:

1. A packet communication quality measuring apparatus for capturing packets flowing in a packet communication network and recording capture times to measure communication quality based on the captured packets, comprising:
a detection unit which detects that a buffer in which the captured packets are stored is full; and
a unit which determines a possibility of a capture failure temporarily occurring when fullness of the buffer is detected.

2. The packet communication quality measuring apparatus according to claim 1, wherein
the detection unit comprises:
a unit which records a time PTm at which one packet Pm is extracted from the buffer and processed;
a unit which determines the number N of stored packets at PTm, when a packet having a capture time CTn earlier than PTm and closest to PTm is Pn, by counting the number of processed packets from Pm to Pn; and
a unit which determines whether N has reached a maximum number Nmax of packets that can be stored in the buffer.

3. The packet communication quality measuring apparatus according to claim 1, wherein
the detection unit comprises:
a unit which determines the number N of stored packets by extracting all packets stored in the buffer at a time; and
a unit determines whether N has reached a maximum number Nmax of packets that can be stored in the buffer.

4. The packet communication quality measuring apparatus according to claim 1, further comprising:
a unit which prevents packets captured in a period in which a capture failure may have occurred from being subjected to packet loss determination based on sequence numbers.

5. A program stored in a computer readable recording medium for causing execution of packet communication quality measuring method in an information processing device provided as a packet communication quality measuring apparatus for capturing packets flowing in a packet communication network while recording capture times to measure communication quality based on the captured packets, the packet communication quality measuring method comprising:
detecting that a buffer in which the captured packets are stored is full; and
determining a possibility of a capture failure temporarily occurring when fullness of the buffer is detected.

6. The program according to claim 5, wherein
the detecting comprises:
recording a time PTm at which one packet Pm is extracted from the buffer and processed;
determining the number N of stored packets at PTm, when a packet having a capture time CTn earlier than PTm and closest to PTm is Pn, by counting the number of processed packets from Pm to Pn; and
determining whether N has reached a maximum number Nmax of packets that can be stored in the buffer.

7. The program according to claim 5, wherein
the detecting comprises:
determining the number N of stored packets by extracting all packets stored in the buffer at a time; and
determining whether N has reached a maximum number Nmax of packets that can be stored in the buffer.

8. The program according to claim 5, further comprising
preventing packets captured in a period in which a capture failure may have occurred from being subjected to a packet loss determination based on sequence numbers.

9. A packet communication quality measuring method for capturing packets flowing in a packet communication network while recording capture times to measure communication quality based on the captured packets, comprising:
detecting that a buffer in which the captured packets are stored is full; and
determining a possibility of a capture failure temporarily occurring when fullness of the buffer is detected.

10. The packet communication quality measuring method according to claim 9, wherein
the detecting comprises:
recording a time PTm at which one packet Pm is extracted from the buffer and processed;
determining the number N of stored packets at PTm, when a packet having a capture time CTn earlier than PTm and closest to PTm is Pn, by counting the number of processed packets from Pm to Pn; and
determining whether N has reached a maximum number Nmax of packets that can be stored in the buffer.

11. The packet communication quality measuring method according to claim 9, wherein
the detecting comprises:
determining the number N of stored packets by extracting all packets stored in the buffer at a time; and
determining whether N has reached a maximum number Nmax of packets that can be stored in the buffer.

12. The packet communication quality measuring method according to claim 9, further comprising:
preventing packets captured in a period in which a capture failure may have occurred from being subjected to a packet loss determination based on sequence numbers.
